(19) United States
(12) Patent Application Publication
(10) Pub. No.: US 2007/0040076 A1
(43) Pub. Date: Feb. 22, 2007

(54) 3D supporting stand for monitors

(76) Inventors: Chia-Jen Chang, Taipei City (TW); Hao-Che Chang, Taipei City (TW)

Correspondence Address: Troxell Law Office Pllc, Suite 1404, 5205 Leesburg Pike, Falls Church, VA, 22041, US

(21) Appl. No.: 11/198,271

(22) Filed: Aug. 8, 2005

(51) Int. Cl. F16M 11/00

(52) U.S. Cl. 248/122.1

(57) ABSTRACT

A 3D supporting stand for monitors uses a plastic metal tube to serve as a movable device, such that he plastic metal tube can perform rotation and movement in multiple angles, and is extended into the holding tube for connection. By means of a latching device inside the holding tube, the plastic metal tube can be adjusted with retraction, thereby increasing an agility of the monitor supporting stand, and enabling the entire structure to move to any angle and reach to a desired position, so as to achieve a variation of 3D multiple angles, and to facilitate increasing a comfort upon viewing in compliance with ergonomics. Moreover, when the plastic metal tube is completely retracted into the holding tube, the monitor can be adjusted to be horizontally or vertically embedded into an object attached by the holding tube for collection, thereby saving a space.

### BACKGROUND OF THE INVENTION

(a) Field of the Invention

The present invention relates to a 3D supporting stand for monitors, and more particularly to a supporting stand wherein a plastic metal tube is used as a movable device for the 3D supporting stand for monitors. The plastic metal tube can be rotated and moved in multiple angles, and can be extended into a holding tube for connection. A latching device is located in the holding tube, so as to retract and protrude the plastic metal tube for adjusting its length.

(b) Description of the Prior Art

Referring to FIG. 1, a body A is a conventional supporting stand for a monitor, wherein a back seat A2 is located at a back side of the monitor A1. As the back seat A2 is connected with a bottom seat A4 through the supporting stand A3, a range of its movement is only limited to a face-up and face-down variation in small angles at the joint between the back seat A1 and the supporting stand A3, without a left and right movement. Therefore, it is easy to cause a fatigue to eyes and a burden to spine under a constant pose in usage, thereby reducing work efficiency.

Moreover, a height of the monitor Al required is dependent on a user; therefore, it is easy to cause a burden to a neck under a fixed height of the entire supporting stand. Accordingly, a foreign object is required to be placed under the bottom seat A4 to increase an entire height in case that the entire height needs to be adjusted, which is very inconvenient.

Accordingly, how to eliminate the aforementioned problems is a technical issue which needs to be solved by the inventor.

### SUMMARY OF THE INVENTION

The present invention is to provide a 3D supporting stand for monitors, wherein a plastic metal tube is used as a movable device for the 3D supporting stand for monitors. The plastic metal tube can be rotated and moved in multiple angles, and can be extended into a holding tube for connection. A latching device is located in the holding tube, so as to retract and protrude the plastic metal tube for adjusting its length.

The plastic metal tube can be completely retracted into the holding tube, such that the monitor can be adjusted to be horizontally embedded into an object attached by the holding tube as a collection operation, thereby saving a space of utilization.

By a means of the plastic metal tube which can perform rotation and movement in multiple angles, the entire monitor supporting stand, associated with the latching device inside the holding tube, can be moved to any angle and reached to any desired position, thereby achieving a variation in 3D multiple angles.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional application.

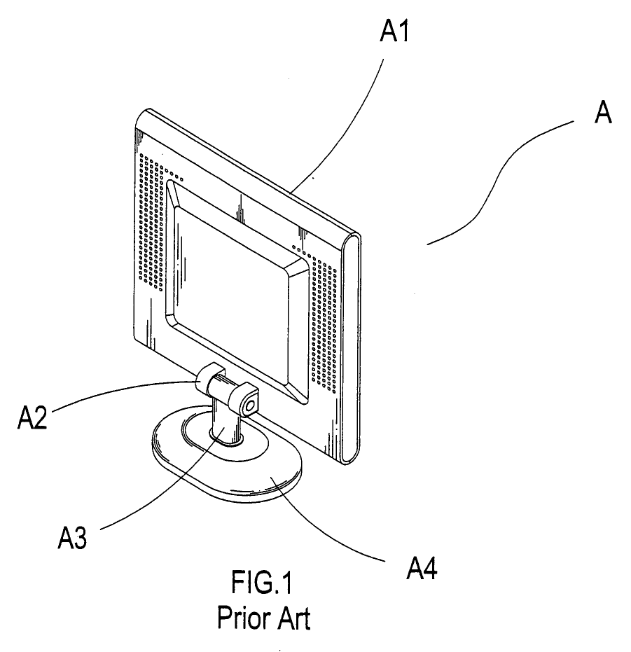

FIG. 2 shows a perspective view of the present invention.

FIG. 3 shows a perspective view of compartments of the present invention.

FIG. 4 shows a cutaway view of the present invention.

FIG. 5 shows a schematic view of an implementation of the present invention.

FIG. 6 shows another schematic view of an implementation of the present invention.

FIG. 7 shows a schematic view of a second implementation of the present invention.

FIG. 8 shows another schematic view of a second implementation of the present invention.

FIG. 9 shows a schematic view of a third implementation of the present invention.

FIG. 10 shows another schematic view of a third implementation of the present invention.

### DETAILED DESCRIPTION OF THE PREFERRED EMBODIMENTS

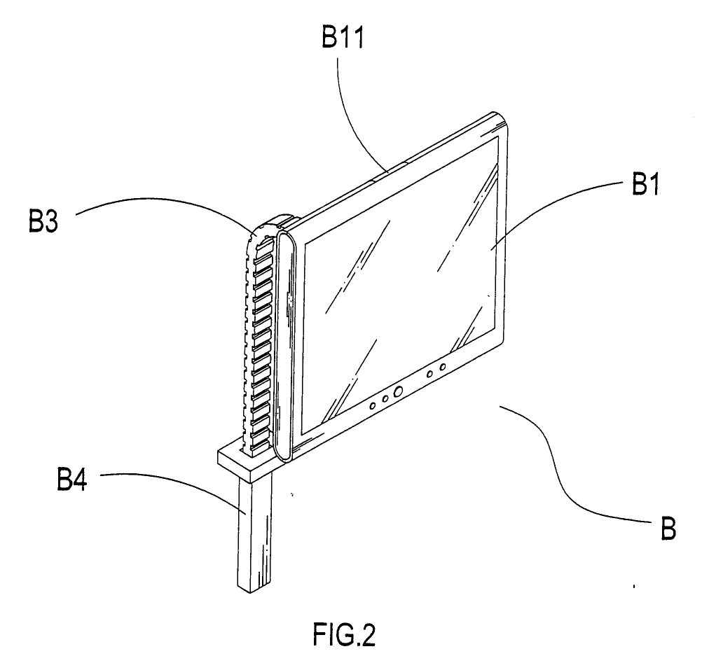

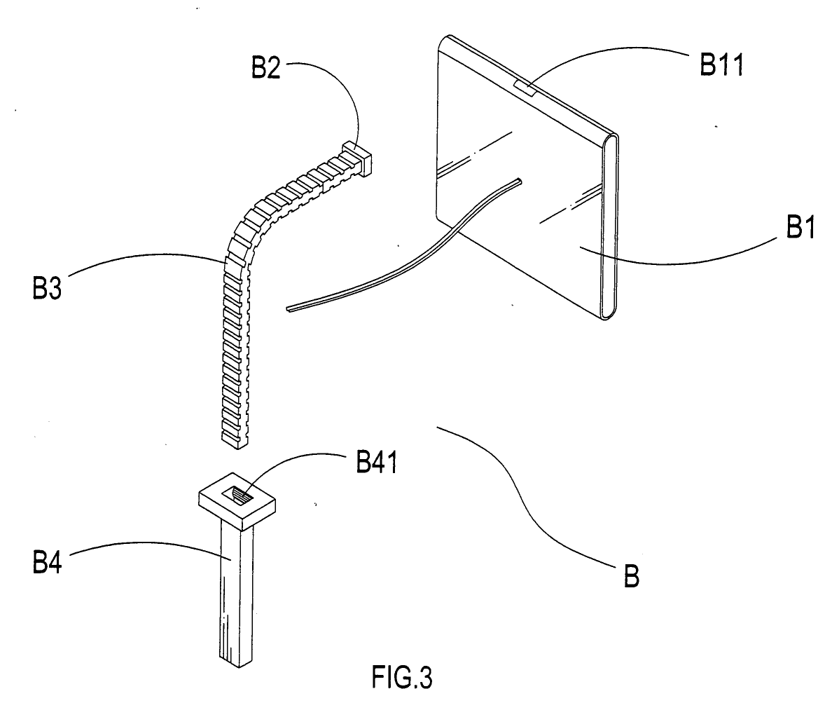

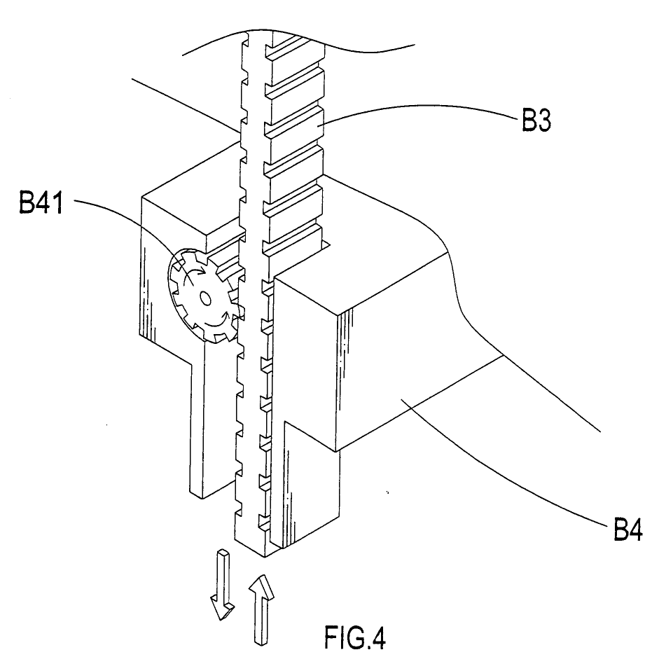

Referring to FIG. 2, FIG. 3, and FIG. 4, a connection device B2 is installed at one side of a monitor B1, in order to connect with a plastic metal tube B3, such that an adjustment of angle can be performed between the monitor B1 and the plastic metal tube B3. The plastic metal tube B3 can be rotated and moved in multiple angles, and can be extended into the holding tube B4 for connection. By a means of a latching device B41 installed inside the holding tube B4, the plastic metal tube B3 can be retracted and protruded inside the holding tube B4 for adjusting the length. Moreover, the holding tube B4 is embedded into an attached object for serving as a fixing and supporting point.

By inter-cooperation of elements of the entire structure, a variation of movement in 3D multiple angles can be generated upon moving the entire supporting stand, which can be moved to a most comfortable position required by a user, thereby changing a constant viewing angle, so as to achieve an effect of ergonomics, and to increase work efficiency.

By completely retracting the plastic metal tube B3 into the holding tube B4, the monitor B1 can be horizontally embedded into the object attached by the holding tube B4, to perform a collection operation, so as to facilitate a collection of entire supporting stand and to save space. A handle slid-proof device B11 is located at an edge of the monitor B1, so as to facilitate a user to exert a force upon retracting and moving the plastic metal tube B3.

A conducting wire B12 required by the monitor B1 is filled in and wanders in the entire supporting stand, and thus can be moved along with the supporting stand.

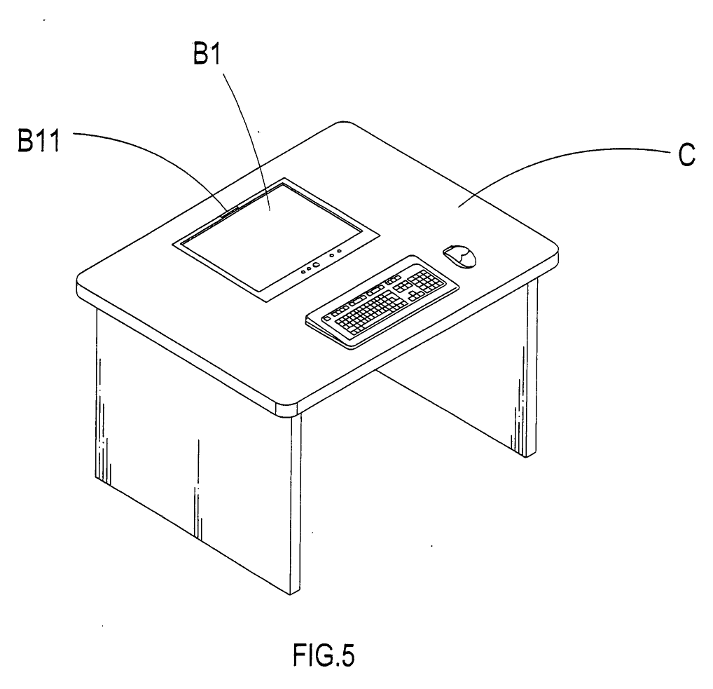

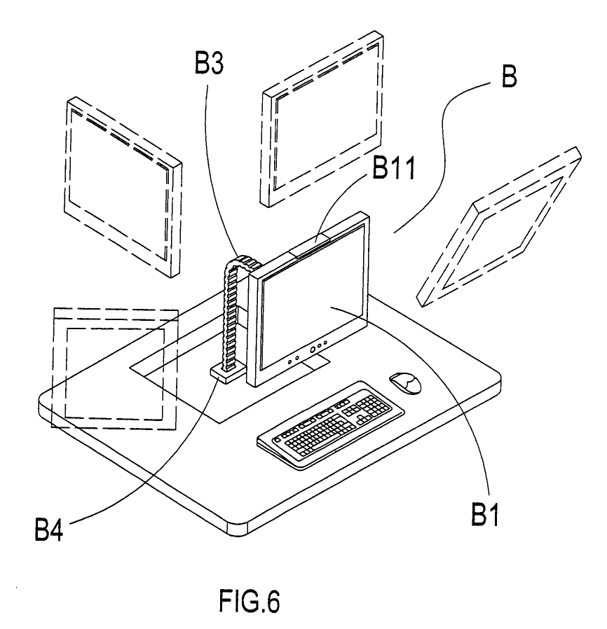

Referring to FIG. 5 and FIG. 6, the monitor B1 is horizontally embedded into a desktop surface of a desk C, in order to save a space of utilization of the desktop surface. The handle slid-proof device B11 is located at an edge of the monitor B1, such that when the position of monitor B1 is to be adjusted, the handle slid-proof device B11 can be pulled to extend the plastic metal tube B3 out of the holding tube B4. In addition, a series of inertia movement is produced by a mutual cooperation among the connection device B2, the plastic metal tube B3, and the holding tube B4, in order to adjust a length and an angle of an entire monitor supporting stand B, so as to facilitate the monitor B1 to be moved to any angle and achieved to a desired position, thereby increasing a mobility and agility of the supporting stand, and performing an optimal adjustment under a most comfortable pose of a user for preventing from a fatigue and increasing efficiency in utilization.

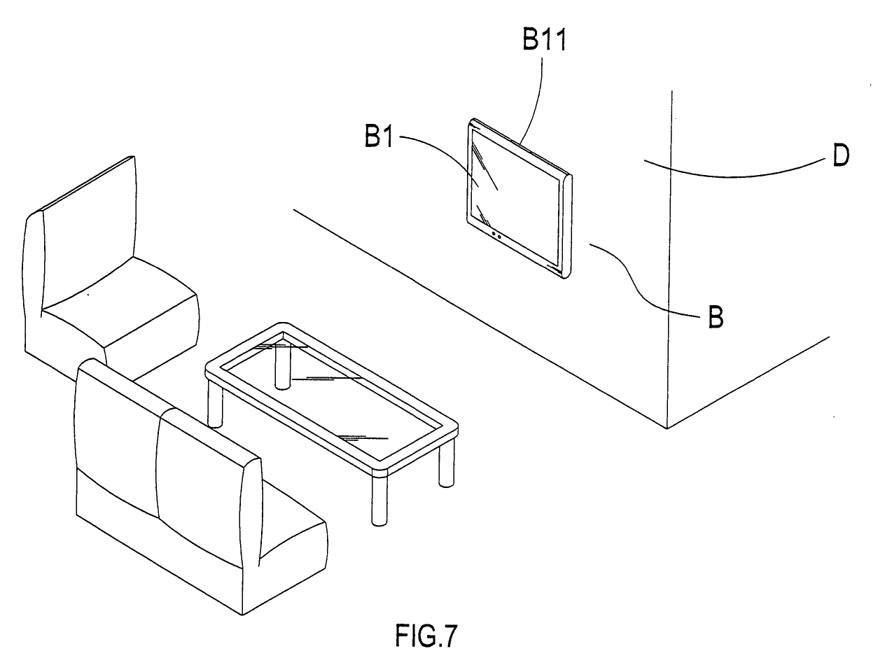

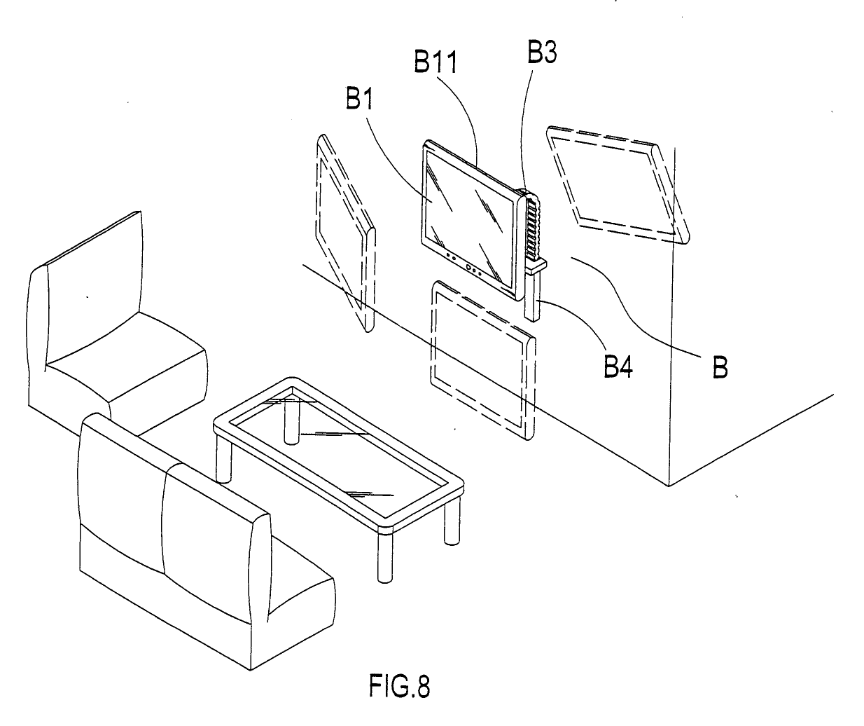

Referring to FIG. 7 and FIG. 8, the monitor B1 can be vertically embedded into a wall D as a collection status. The handle slid-proof device B11 is located at an edge of the monitor B1. The plastic metal tube B3 can be extended out of the holding tube B4 upon pulling out the handle slid-proof device B11. In addition, by a series of aforementioned inertial movement of the entire monitor supporting stand B, the monitor B1 can be adjusted to any angle and moved to a desired position, so as to adjust properly by a preference of user upon viewing, thereby increasing a convenience of comfort in utilization. On the other hand, the plastic metal tube B3 can also be completely retracted into the holding tube B4, so as to vertically embed the monitor B1 into the wall D, thereby accomplishing the collection operation.

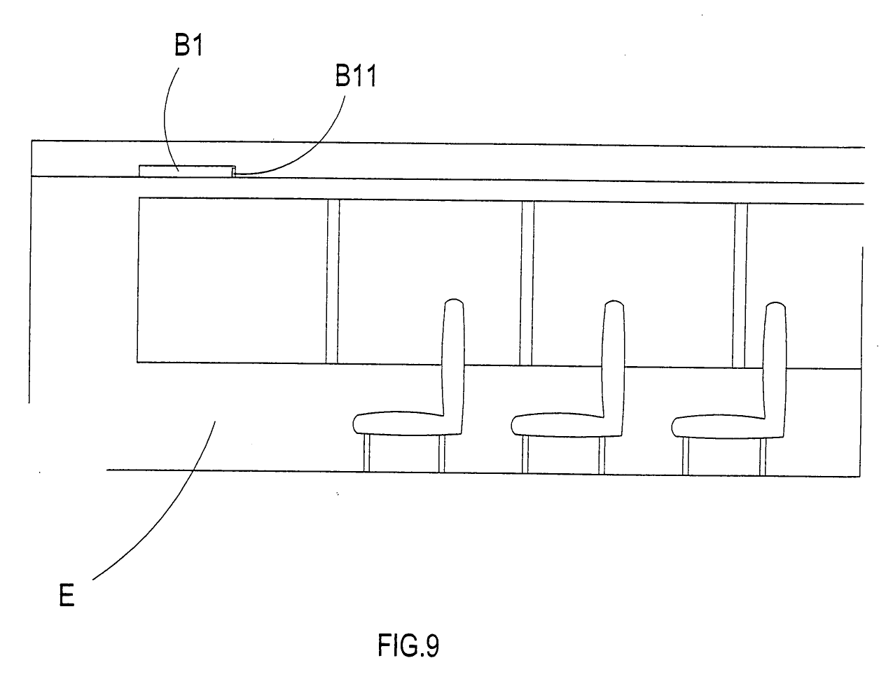

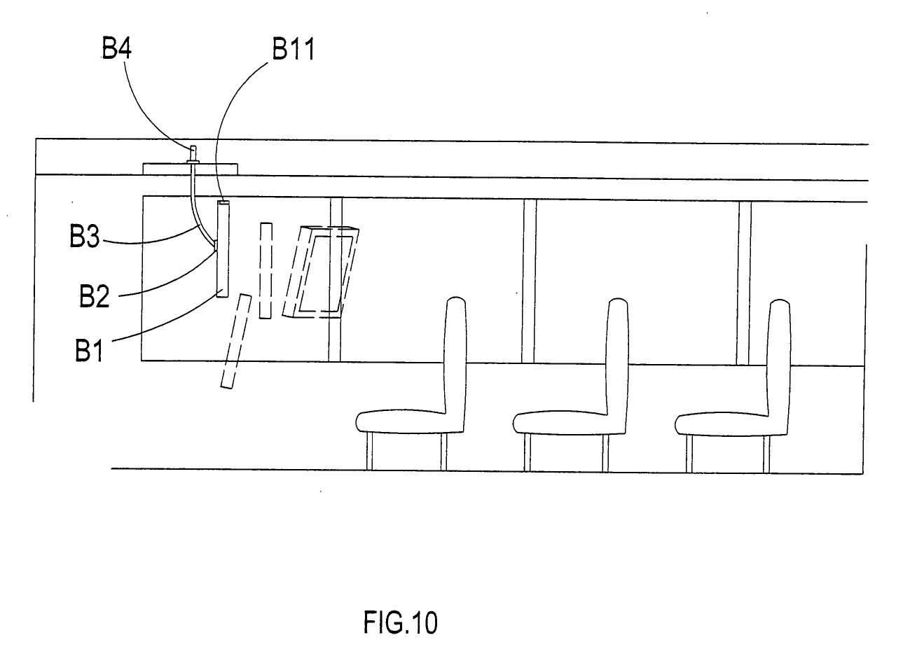

Referring to FIG. 9 and FIG. 10, the monitor B1 can be vertically embedded into a top end in an interior of a transportation vehicle E as a collection status. The handle slid-proof device B11 is located at an edge of the monitor B1. The plastic metal tube B3 can be extended out of the holding tube B4 upon pulling down the handle slid-proof device B11. In addition, a series of inertial movement is produced by an inter-cooperation among the connection device B2, the plastic metal tube B3, and the holding tube B4, such that the monitor B1 can be adjusted to any angle and moved to a desired position. On the other hand, by the aforementioned inertial movement, the monitor B1 can be vertically embedded in the top end of the transportation vehicle E, to accomplish the collection operation. This collection design of vertical embedding without occupying space can be used to enlarge a size of the monitor B1, thereby breaking through a bottleneck of a conventional small monitor, and in turn providing a better visual effect. To further manifest the advancement and practicability of the present invention, the present invention is compared with a conventional application as follow:

Shortcomings of a conventional application

(1) The supporting stand is a fixed body formed integrally, which cannot move position and change angles.

(2) A change of face-up and face-down angles that can be adjusted to the monitor is small.

(3) The height of the monitor is dependent on the length of supporting stand, thus cannot be changed.

(4) It is easy to cause a fatigue to eyes and a burden to spine while using the monitor with a fixed position, thereby reducing work efficiency.

(5) It cannot be moved following a position required by a user, which causes the user needs to move to match the supporting stand.

Advantages of the Present Invention

(1) The entire monitor supporting stand is constituted by assembling and operates by an interconnected movement which is mutually cooperated, thereby easy to move and change freely.

(2) The monitor can be adjusted and rotated in multiple angles to change viewing angles.

(3) It has a high mobility and can be moved agilely, wherein the supporting stand matches a movement of a user.

(4) An optimal adjustment can be performed under a most comfort pose of a user, which can reduce radiation and prevent from fatigue, thereby increasing work efficiency.

(5) The entire monitor supporting stand can be embedded horizontally or vertically into an object attached by the holding tube for collection, thereby achieving a purpose of saving a space of utilization.

(6) It has an advancement and practicability; no matter a user is standing, crouching, sitting or lying, it can all be adjusted to a proper position for use.

(7) It can promote an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A 3D supporting stand for monitors comprising a connection device, a plastic metal tube, and a holding tube, wherein the connection device is located at one side of the monitor and connected with the plastic metal tube which is a movable device of the entire supporting stand and is extended into the holding tube for fixing with a latching device installed inside the holding tube, such that the length of the plastic metal tube can be adjusted in the holding tube; the entire supporting stand being able to perform adjustment of any length and variation of any angle, so as to facilitate an optimal adjustment in an angle and apposition of the monitor under any pose of a user, thereby achieving an effect of being compliance with ergonomics, by a means of mutual cooperation among the connection device, the plastic metal tube, and the holding tube; a handle slid-proof device being located at an edge of the monitor so as to facilitate a movement of extending and protruding of the plastic metal tube inside the holding tube, and to provide a place for exerting a force to a user upon moving and adjusting the position of the entire monitor supporting stand; the entire monitor supporting stand being able to embedded horizontally into an object attached by the holding tube for collection, so as to facilitate the collection and save space, thereby keeping a desktop to be clean and beautiful.

2. The 3D supporting stand for monitors according to claim 1, wherein the connection device can be further a universal connector, transversal connector, longitudinal connector, and other related device with a latching movement.

3. The 3D supporting stand for monitors according to claim 1, wherein the plastic metal tube and the holding tube can be further installed on a monitor, lightening equipment, and other related equipment having a displaying function.

4. The 3D supporting stand for monitors according to claim 1, wherein the monitor supporting stand can be further applied to a monitor in a transportation vehicle, a family theater, and other related equipment having a video/audio effect.
